(19) United States
(12) Patent Application Publication
(10) Pub. No.: US 2024/0388546 A1
(43) Pub. Date: Nov. 21, 2024

(54) SYSTEM AND METHOD FOR AN OPTIMIZED STAGING BUFFER FOR BROADCAST/MULTICAST OPERATIONS

(71) Applicant: Enfabrica Corporation, Mountain View, CA (US)

(72) Inventors: Shrijeet Mukherjee, Mountain View, CA (US); Thomas Norrie, Mountain View, CA (US); Ari Aravinthan, Mountain View, CA (US); Gurjeet Singh, Mountain View, CA (US); Raghu Raja, Mountain View, CA (US); Shimon Muller, Mountain View, CA (US)

(21) Appl. No.: 18/666,548

(22) Filed: May 16, 2024

Related U.S. Application Data
(60) Provisional application No. 63/502,518, filed on May 16, 2023.

(51) Int. Cl. H04L 49/90; H04L 49/118

(52) U.S. Cl. CPC H04L 49/9036; H04L 49/118; H04L 49/9084

(57) ABSTRACT

A system for using staging buffers in broadcast or multicast operations is disclosed. In some embodiments, the system comprises a server fabric adapter (SFA) communicatively coupled to a plurality of accelerators. The system is configured to provide a memory tier that is accessed by the plurality of accelerators; receive data in a send queue of the memory tier; establish an association between buffers of the send queue and one or more receive queues based on a pattern of sharing defined by one or more of the plurality of accelerators; and transmit the data to the one or more accelerators by sending the data from the send queue to the one or more receive queues based on the association.

### CROSS REFERENCE TO RELATED APPLICATION

This application claims the benefit of U.S. Provisional Patent Application No. 63/502,518, titled “System and Method for an Optimized Staging Buffer for Broadcast/Multicast Operations” and filed May 16, 2023, the entire contents of which are incorporated by reference herein.

### TECHNICAL FIELD

This disclosure relates to creating a memory tier to provide sufficiently large capacity without increasing the memory bandwidth requirements.

### BACKGROUND

Developers of modern computer architectures have strived to find a way to build memory hierarchies that provide an optimal tradeoff between latency and capacity. Memory hierarchy is an enhancement to organize memory to help optimize the access time and the memory available in a computer. Ideally, the capacity at each level in the hierarchy should be sufficient to fit the entire context for a compute operation while hiding the latency of fetching data and instructions from the next layer below that level. However, memory hierarchy may not perform well in emerging computing areas, such as graphics processing units (GPUs), machine learning accelerators, etc., where potentially large data blocks may need to be distributed over large page sizes.

### SUMMARY

To address the aforementioned shortcomings, a system for using staging buffers in broadcast or multicast operations is disclosed. In some embodiments, the system comprises a server fabric adapter (SFA) coupled to a variety of accelerators. The system is configured to provide a memory tier that is accessed by the accelerators, receive data in a send queue of the memory tier, establish an association between buffers of the send queue and one or more receive queues based on a pattern of sharing defined by one or more of the accelerators, and transmit the data to the one or more accelerators by sending the data from the send queue to the one or more receive queues based on the association.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles, and features explained herein may be employed in various and numerous embodiment.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A-1C illustrate an exemplary compute express link (CXL) memory hierarchy, according to some embodiments.

FIG. 2 illustrates an exemplary staging buffer for broadcast/multicast operations, according to other embodiments.

FIG. 3 illustrates an exemplary server fabric adapter architecture for accelerated and/or heterogeneous computing systems, according to some embodiments.

FIG. 4 illustrates an exemplary process of performing broadcast or multicast operations using staging buffers, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Memory Hierarchy

Based on peripheral component interconnect express (PCIe) 5.0, compute express link (CXL) is published as an open standard for high-speed CPU-to-device and CPU-to-memory interconnection. CXL is designed to accelerate the performance of next-generation data center servers. CXL is built on the PCIe physical and electrical interfaces with protocols in three key areas: I/O, cache, and memory coherence, i.e., CXL.io, CXL.cache, and CXL.mem. CXL technology maintains memory coherency between the CPU memory space and memory on attached devices, which allows resource sharing for higher performance, reduced software stack complexity, and lower overall system cost.

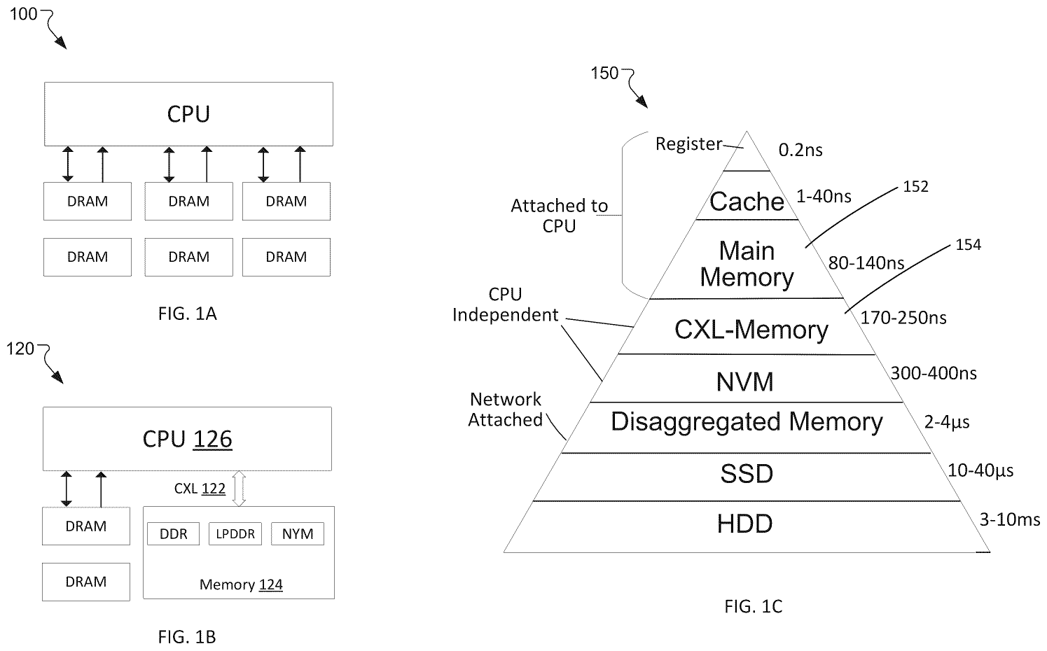

Due to the surge in memory needs and increasing (dynamic random-access memory) DRAM cost, various approaches have been developed to address this problem. One approach is to build tiered memory subsystems and add higher memory at a higher level. FIGS. 1A-1C illustrate existing memory tiers. When CXL is not used, as shown in FIG. 1A, the system 100 has significantly higher latencies, and the performance is degraded. CXL mitigates this by providing an intermediate latency operating point with DRAM-like bandwidth and cache-line granular access semantics. As shown in system 120 of FIG. 1B, CXL serves as a new memory bus 122 to attach memory 124 to CPU 126. CXL decouples the memory 124 from CPU 126, thereby allowing more flexibility in memory subsystem design and fine-grained control over the memory bandwidth and capacity. A tiered memory subsystem or hierarchy is further detailed in FIG. 1C.

Memory hierarchy separates computer storage into a hierarchy based on response/access time. FIG. 1C illustrates memory tiers and latencies for an existing memory hierarchy 150. As shown, there are multiple tiers/levels (e.g., 152, 154) present in memory hierarchy 150, with multiple sizes, accessing times, etc. Capacity is a global volume of data that memory in each tier/level can store. Capacity increases from top to bottom in memory hierarchy 150. Access time is the time interval between a read/write request and available data, which also increase from top to bottom in memory hierarchy 150.

In general, for a CXL memory tier 154 to be a viable option to meet high-performance computational needs, the capacity provided by a preceding main memory tier 152 has to be sufficiently large such that a transfer time to move a block from the CXL memory tier 154 to the main memory tier 152 is trivial and/or can be hidden, for example, because there is enough context for a compute operation in the main memory tier 152 to not stall the compute operation. In this way, accessing memory over CXL may not introduce significantly more latency. In other words, this can enable the addition of the CXL memory tier 154 which is independent of the CPU and can allow the tier 154 to be added or changed without disturbing other portions of an associated data center. Further, this can allow memory technologies to be decoupled from server systems, thereby driving even more efficiency.

The memory hierarchy 150 shown in FIG. 1C, however, generally does not perform well in emerging areas of computing, such as with GPUs and machine learning (ML) accelerators, where information tends to be large blocks of data and may need to be distributed over large page sizes. For example, the information needed for GPUs and ML accelerators tends to be blocks of data within much larger data sets and is thus sparsely accessed. The dominant pattern of use is therefore to provide a higher tier of much larger capacity of unstranded memory, and this memory of larger capacity can be accessed in large streaming blocks instead of cache line sized load/store operations.

Advantageously, the system and method described herein can allow external memory (e.g., in CXL.mem or any other headless memory form) to provide sufficiently large capacity without proportionally increasing memory bandwidth requirements as the number of accelerators that access the memory increases.

### System Architecture

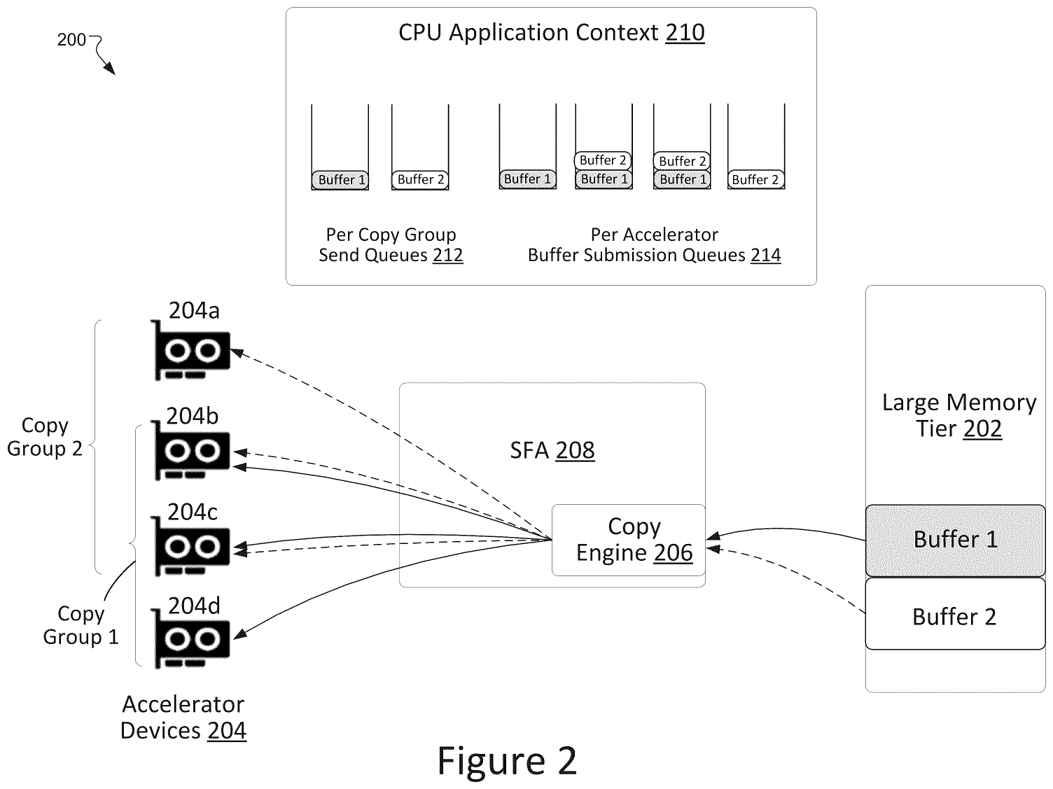

FIG. 2 illustrates an exemplary staging buffer structure 200 for broadcast/multicast operations, according to some embodiments. A device may have and expose different memory types with heaps of various sizes and different properties. One memory type may be, for example, a device local memory located on graphics double data rate (GDDR) chips. Accessing such memory can be fast because it may be accessible only to a graphics card or GPU and may not involve data transfer over slower interconnects (e.g., cannot be directly written by a host or CPU). In various examples, a staging buffer can be an intermediate or temporary resource used to transfer data from slower interconnects (e.g., a CPU) to device visible, host non-visible memory (e.g., GPU memory). In broadcast/multicast operations, one or more senders and one or more receivers can participate in data transfer simultaneously.

The present system can create and utilize a large memory tier 202 in a memory hierarchy. The memory tier 202 can provide large capacity and can be accessed by a variety of accelerator devices or accelerators 204. An accelerator device includes microprocessors that can accelerate certain workloads. An accelerator may be or include, for example, a GPU, a vision processing unit (VPU), a digital signal processor (DSP), a tensor processing unit (TPU), a non-volatile memory express solid state drive (NVMe SSD), etc. In some embodiments, the accelerator devices 204 can define or be assigned to one or more patterns of sharing. In standard computer systems, data striping may allow data segments to be simultaneously spread across multiple storage devices (e.g., double data rate synchronous dynamic random-access memory (DDR SDRAM)) when a single storage device cannot work fast enough to process a data request (e.g., DDR generally is slower than the buses that connect to it). However, data striping cannot be applied in external memory such as CXL. In this case, since a CPU issues a load or store operation that targets a specific port, no striping across ports or multiple devices can be done. Here, with patterns of sharing, read/write commands can be issued across different memory regions mapped to different ports, thereby achieving the parallel access needed for throughput increase. Each pattern of sharing, referred to as a copy group, can be or include a collection of one or more accelerator devices from the accelerator devices 204. A pattern of sharing can be used to achieve a most efficient use of memory bandwidth available from the large memory tier 202. As shown in FIG. 2, each of copy groups 1 and 2 corresponds to a respective set of accelerator devices 204.

Advantageously, in various examples, a bandwidth demand for a read operation on large memory tier 202 may not increase with the number of accelerators 204. In other words, compared to previous memory hierarchies (e.g., memory hierarchy 150 in FIG. 1), a higher tier of larger capacity unstranded memory (e.g., large memory tier 202) can be used to allow data access in large streaming blocks without proportionally increasing memory bandwidth requirements.

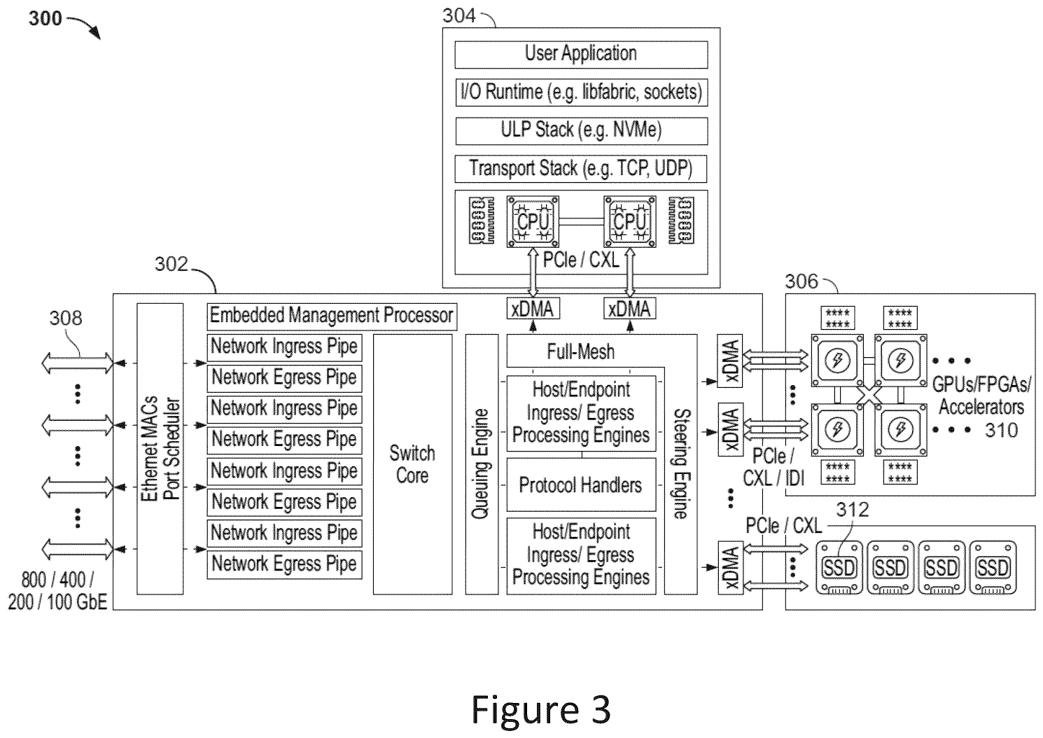

In some embodiments, the present system may allow the large memory tier 202 may include or be assembled from one or more coherent memory blocks (e.g., CXL memory 154 in FIG. 1). With coherent memory blocks, two or more processors or cores share a common memory space, ensuring the data consistence in a multiprocessor or multicore system. In other embodiments, large memory tier 202 may be a standard compute unit attached via PCIe. Additionally or alternatively, a copy engine 206 of a server fabric adapter (SFA) 208 can be used to direct memory access (DMA) from the large memory tier 202. An exemplary structure of the SFA 208 will be described in detail with reference to FIG. 3.

The systems and methods described herein have other beneficial features. In some embodiments, for example, an arbitrary number of copy groups may be created. The copy groups can provide ultimate flexibility in various operations. For example, the copy groups can be used to optimize both an accelerator write bandwidth and a large memory tier read bandwidth. Further, a copy through copy groups is reliable, even though it may include multiple destinations, and thus be subject to variances in speed, capabilities, and errors associated with various accelerators 204. Typically, data is copied across memory using a source descriptor and a destination descriptor, where each descriptor specifies a list of device, start address, and data length. As disclosed herein, SFA 208 copies data from a list of source descriptors (i.e., source list) to a list of destination descriptors (i.e., destination list). SFA 208 proceeds to read data based on the queue where the source descriptors reside, interprets the source descriptors to discern the list of destination queues, and then writes the data to buffers in the destination descriptors that are found in the destination queue. SFA 208 thus can linearly copy data from the source list into the destination list, where each element in the source list may specify the device or port from which data was sent, and every element in the destination list defines how the received data will be laid out. In this way, the variances of accelerators will not influence the data transmission since data is transmitted to one accelerator and then to another accelerator. In some embodiments, an indicator is used to precisely show drops and errors in data transfer.

In certain examples, a primitive is a calling function between memory layers for managing data communications. In various embodiments, some or all primitives used in the present system can be built from networking multicast pipelines. As such, the primitives used in the present system may run any networking protocol on top of copy engine 206 to create a larger network topology of multicast or broadcast operations.

### System Features

In some embodiments, the present system may establish a one-to-one or one-to-many (e.g., 1:N, where N≥1) association between a send queue and a set of receive queues. The send queue is associated with the large memory tier 202. In various examples, the send queue can include or utilize buffers in the large memory tier 202 to perform broadcast or multicast operations. The set of receive queues is associated with the accelerators 204. In various examples, a receive queue can be or include a queue of buffer pointers where data may be stored. A send queue can be or include a queue of buffers for sending data. The present system can associate a pair of send and receive queues, such that any contents of a buffer in the send queue can be transferred to buffers in the receive queue (e.g., corresponding to a copy group).

In general, messages and buffers may be consumed up to the boundaries of a receive buffer. A receiver always posts a buffer of a maximal message size, i.e., the largest number of bytes that can be transmitted as a message to an application waiting for it. The sender however may have the data less than that maximal size to send. When the sender sends the data with the size less than the maximal message size, (1) the receiver either waits for more bytes in the case of stream oriented protocols, (2) or upon receiving the sender's indication that a message is complete, the receiver completes the message reception and handles the full message buffer to the application in the case of message oriented data transmission. The present system may handle either stream or message oriented data transmission, and the message and buffers are limited to the boundary of the receiver in either cases.

The association of a send queue to a receive queue may be one to many such that a byte from the send buffer will occupy a byte in each of the current buffers of the receive queue. In some embodiments, if any of the receive queues has an error or insufficient space, the present system may generate and provide an error descriptor in the queue(s) to show it has the error or insufficient space. In some embodiments, the sender (e.g., an application, CPU) that is putting entries in the send queue may be configured to check if any of the receive queues includes an error descriptor. Responsive to a receive queue including an error descriptor, the sender may resend the data only to this specific queue since this queue never received the data.

In some embodiments, the association of a send queue to a receive queue may be built on a Layer 2 or L2 networking model. When sending data directly from a send queue to a single receive queue, the send queue sends data to an L2 address. An L2 address is a media access control (MAC) address along with a virtual local area network (VLAN) number, i.e., a unique MAC address, attached to a physical network interface.

When sending data from one send queue to a set of receive queues, the send queue sends data to a multicast L2 address. This multicast L2 address represents a list of actual destination L2 addresses. In this way, a copy operation is a unicast read from the source large memory tier 202 and a multicast write to each member of the multicast group (e.g., accelerators of copy groups 1 or 2).

Using the aforementioned send queue, receive queue, and association between the send and receive queues, the present system may effectively implement a reliable multicast topology inside an SFA. While only two copy groups are illustrated in FIG. 2, further multiple independent groupings (of arbitrary number) may be formed in the present system, where each group communication can be isolated from the others.

In some embodiments, the queues used in the present system may be implemented as queues managed by software. In other embodiments, the queues may be embedded queues in hardware. Regardless of how queues are implemented, the same functionality described herein may be performed.

It should be noted that send buffers can be used in a zero-copy manner as receive buffers. The send buffers are buffers used to send data, and the receive buffers are used to land bytes from a network card. With zero-copy, data is not duplicated between buffers and thus avoids redundant copies.

The present system enables communication buffers backed by pages in the large memory tier (e.g., 202). In some embodiments, this may require (1) the send queue to send data to a set of receive queues with a multicast L2 address and (2) send buffers and/or receive buffers work in a zero-copy manner.

In some embodiments, when data lands in the buffers (e.g., buffer 1, buffer 2) of large memory tier 202, the present system may enqueue the same buffers as send buffer elements. When the present system starts to transmit the data, it configures the send descriptor to point to the payload that was received as a communication buffer, and the data will be sent out as a multicast to a pre-created copy group (e.g., copy group 1, copy group 2). In other words, a communication buffer (e.g., buffer 1, buffer 2) is allocated from the large memory tier 202 to receive or land data from the network. When an application requests to multicast or send replicas of the data to multiple destinations or destination accelerators using a set of send descriptors and receive descriptors, the present system creates a copy group including the multiple destination accelerators. The present system is then configured to point the send descriptor to the memory where the data or network payload landed, i.e., the communication buffer, and post receive descriptors for each of the recipients, i.e., the destination accelerators in the copy group. As a result, when sending the data using the send descriptor, the present system can deposit a data copy into a receive buffer in each of the multicast destination queue associated with the multiple destination accelerators.

As shown in FIG. 2, when the data is enqueued (e.g., written by CPU) into buffer 1 and/or buffer 2 of large memory tier 202, each queue is configured to be a send queue to associate with one or more receive queues and to transmit the data to one or more destinations (e.g., accelerators) based on the associations or copy groups. For example, copy engine 206 of SFA 208 may be configured to transmit the data in buffer 1 of large memory tier 202 to accelerators 204b, 204c, and 204d in copy group 1 (shown with solid lines), and transmit the data in buffer 2 of large memory tier 202 to accelerators 204a, 204b, and 204c in copy group 2 (shown with dashed lines).

A copy group may include specific accelerator members. It can be seen from CPU application context 210, that each copy group is associated with only send queues from a single buffer as shown in 212. However, each accelerator member in a copy group may receive data on buffer submission queues from one or more send buffers as shown in 214. A buffer submission queue is used to submit or post a buffer to receive the data. For example, while certain accelerators (e.g., 204a, 204d) each receive the data from either buffer 1 or buffer 2, the other two accelerators (e.g., 204b, 204c) receive the data from both buffers 1 and 2. In this way, large memory tier 202 can be created to allow data access in large streaming blocks without proportionally increasing the memory bandwidth requirements.

In some embodiments, with more independent groupings being formed and each group communication being isolated from others, the present system is also capable of performing collective operations, such as Broadcast or AllGather. Each copy group may be referred to as a collective. For each collective or copy group, the present system can indicate a multicast L2 address. In such a scenario, moving data into a set of accelerators that form a collective may be implemented by the present system creating a multicast group with the selected accelerators and using a collective operation to move the data into parts of the large tier memory.

Reduction-based collectives, such as AllReduce or ReduceScatter, may also be formed. In some embodiments, the present system may implement these extended collective operations by first copying the pre-reduction data into a reduction accelerator (either externally attached or built-in), performing a reduction computation, and then performing the post-reduction broadcast, where the post-reduction broadcast operation includes creating a multicast group with the selected accelerators and using the collective operation to move the data into parts of the large tier memory as discussed above. In some embodiments, these phases for forming the reduction-based collectives may be pipelined to increase the performance. Additionally, the amount of bandwidth in the reduction accelerators may also be increased to improve the performance.

In some embodiments, a large tier memory may exist in the context of a home or root (e.g., 210). SFA 208 may act as the root for the memory and present a virtualized view of the memory to the CPU and the accelerator complexes. This allows the CPU to write to the large tier memory (e.g., 202) as if it was local memory to the CPU, and SFA 208 via its copy engine 206 is able to copy data from the large tier memory 202 into the memory of accelerators 204.

In some embodiments, when SFA 208 acts as the root for memory to allow the CPU to write to large tier memory 202, the CPU access may be mediated by having SFA 208 present a CXL.mem device to the CPU. This device is distinct from the CXL.mem device attached to SFA 208. The CPU loads and stores to the SFA-presented CXL.mem device, which is then bridged/rewritten by SFA 208 to target the appropriate SFA-attached CXL.mem device. In this way, CPU load/store accesses and SFA DMA accesses to the same CXL.mem devices can be mixed in a non-conflicting way. In some embodiments, software-managed coherency on the CPU may be required.

### Implementation System

FIG. 3 illustrates an exemplary server fabric adapter architecture 300 for accelerated and/or heterogeneous computing systems in a data center network. The server fabric adapter (SFA) 302 of FIG. 3 may be used to implement the flow control mechanism as shown in FIGS. 1 and 2. In some embodiments, SFA 302 may connect to one or more controlling hosts 304, one or more endpoints 306, and one or more Ethernet ports 308. An endpoint 306 may be a GPU, accelerator, FPGA, etc. Endpoint 306 may also be a storage or memory element 312 (e.g., SSD), etc. SFA 302 may communicate with the other portions of the data center network via the one or more Ethernet ports 308.

In some embodiments, the interfaces between SFA 302 and controlling host CPUs 304 and endpoints 306 are shown as over PCIe/CXL 314a or similar memory-mapped I/O interfaces. In addition to PCIe/CXL, SFA 302 may also communicate with a GPU/FPGA/accelerator 310 using wide and parallel inter-die interfaces (IDI) such as Just a Bunch of Wires (JBOW). The interfaces between SFA 302 and GPU/FPGA/accelerator 310 are therefore shown as over PCIe/CXL/IDI 314b.

SFA 302 is a scalable and disaggregated I/O hub, which may deliver multiple terabits-per-second of high-speed server I/O and network throughput across a composable and accelerated compute system. In some embodiments, SFA 302 may enable uniform, performant, and elastic scale-up and scale-out of heterogeneous resources. SFA 302 may also provide an open, high-performance, and standard-based interconnect (e.g., 800/400 GbE, PCIe Gen 5/6, CXL). SFA 302 may further allow I/O transport and upper layer processing under the full control of an externally controlled transport processor. In many scenarios, SFA 302 may use the native networking stack of a transport host and enable ganging/grouping of the transport processors (e.g., of x86 architecture).

As depicted in FIG. 3, SFA 302 connects to one or more controlling host CPUs 304, endpoints 306, and Ethernet ports 308. A controlling host CPU or controlling host 304 may provide transport and upper layer protocol processing, act as a user application “Master,” and provide infrastructure layer services. An endpoint 306 (e.g., GPU/FPGA/accelerator 310, storage 312) may be producers and consumers of streaming data payloads that are contained in communication packets. An Ethernet port 308 is a switched, routed, and/or load balanced interface that connects SFA 302 to the next tier of network switching and/or routing nodes in the data center infrastructure

In some embodiments, SFA 302 is responsible for transmitting data at high throughput and low predictable latency between:
Network and Host;
Network and Accelerator;
Accelerator and Host;
Accelerator and Accelerator; and/or
Network and Network.

In general, when transmitting data/packets between the entities, SFA 302 may separate/parse arbitrary portions of a network packet and map each portion of the packet to a separate device PCIe address space. In some embodiments, an arbitrary portion of the network packet may be a transport header, an upper layer protocol (ULP) header, or a payload. SFA 302 is able to transmit each portion of the network packet over an arbitrary number of disjoint physical interfaces toward separate memory subsystems or even separate compute (e.g., CPU/GPU) subsystems.

By identifying, separating, and transmitting arbitrary portions of a network packet to separate memory/compute subsystems, SFA 302 may promote the aggregate packet data movement capacity of a network interface into heterogeneous systems consisting of CPUs, GPUs/FPGAs/accelerators, and storage/memory. SFA 302 may also factor, in the various physical interfaces, capacity attributes (e.g., bandwidth) of each such heterogeneous systems/computing components.

In some embodiments, SFA 302 may interact with or act as a memory manager. SFA 302 provides virtual memory management for every device that connects to SFA 302. This allows SFA 302 to use processors and memories attached to it to create arbitrary data processing pipelines, load balanced data flows, and channel transactions towards multiple redundant computers or accelerators that connect to SFA 302. Moreover, the dynamic nature of the memory space associations performed by SFA 302 may allow for highly powerful failover system attributes for the processing elements that deal with the connectivity and protocol stacks of system 300.

### Flow Diagram

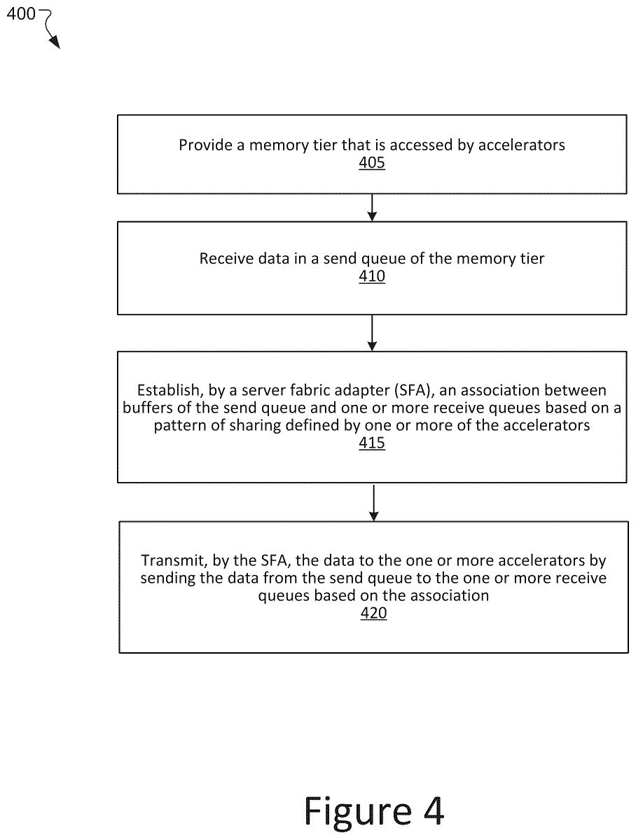

FIG. 4 illustrates an exemplary process of performing broadcast or multicast operations using stagging buffers, according to some embodiments. Process 400 is implemented by a server fabric adapter (e.g., SFA 208) that is communicatively connected over network(s) with other devices such as a variety of accelerators.

At step 405, a memory tier that is accessed by a plurality of accelerators is provided. In some embodiments, providing the memory tier comprises assembling the memory tier from coherent memory blocks such as CXL memory. In other embodiments, creating the memory tier comprises attaching a standard compute unit via PCIe.

At step 410, data is received in a send queue of the memory tier. The SFA can be configured to present a virtualized view of memory to a CPU and one or more accelerators such that the CPU can access and write the data into the send queue of the memory tier, and the SFA can copy the data from the memory tie into memory of the one or more accelerators.

At step 415, an association is established between buffers of the send queue and one or more receive queues based on a pattern of sharing defined by one or more of the plurality of accelerators. The one or more accelerators defining the pattern of sharing form a copy group. In some embodiments, an arbitrary number of copy groups can be created to provide sufficient capacity without increasing memory bandwidth requirements.

At step 420, the SFA is configured to transmit the data to the one or more accelerators by sending the data from the send queue to the one or more receive queues based on the association. In some embodiments, the data is transmitted from the send queue directly to a single receive queue using a MAC address combined with a VLAN number. In other embodiments, the data is transmitted from the send queue to multiple receive queues using a multicast address, wherein the multicast address represents a list of destinations' addresses, and each destination's address includes a MAC address combined with a VLAN number.

### Additional Considerations

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer-readable medium. The storage device 830 may be implemented in a distributed way over a network, for example as a server farm or a set of widely distributed servers, or may be implemented in a single computing device.

Although an example processing system has been described, embodiments of the subject matter, functional operations, and processes described in this specification can be implemented in other types of digital electronic circuitry, in tangibly-embodied computer software or firmware, in computer hardware, including the structures disclosed in this specification and their structural equivalents, or combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other units suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for using staging buffers in broadcast or multicast operations comprising:
providing a memory tier that is accessed by a plurality of accelerators;
receiving data in a send queue of the memory tier;
establishing, by a server fabric adapter (SFA), an association between buffers of the send queue and one or more receive queues based on a pattern of sharing defined by one or more of the plurality of accelerators; and
transmitting, by the SFA, the data to the one or more accelerators by sending the data from the send queue to the one or more receive queues based on the association.

2. The method of claim 1, wherein providing the memory tier comprises at least one of:
assembling the memory tier from coherent memory blocks including compute express link (CXL) memory; or
attaching a standard compute unit via peripheral component interconnect express (PCIe).

3. The method of claim 1, wherein the association is one-to-one, and wherein transmitting the data from the send queue to the one or more receive queues comprises sending the data directly to a single receive queue using a media access control (MAC) address combined with a virtual local area network (VLAN) number.

4. The method of claim 1, wherein the association is one-to-many, and wherein transmitting the data from the send queue to the one or more receive queues comprises sending the data to multiple receive queues using a multicast address, wherein the multicast address represents a list of destinations' addresses, and each destination's address includes a MAC address combined with a VLAN number.

5. The method of claim 1, further comprising:
generating and providing an error descriptor in a receive queue from the one or more receive queues when the receive queue has an error or insufficient space; and
resending, via the SFA, the data to the receive queue in response to determining that the receive queue includes an error descriptor.

6. The method of claim 1, wherein the one or more accelerators defining the pattern of sharing form a copy group.

7. The method of claim 6, further comprising creating an arbitrary number of copy groups to provide sufficient capacity without increasing memory bandwidth requirements.

8. The method of claim 7, further comprising performing collective operations, wherein the SFA is configured to move the data to selected accelerators by creating a multicast group with the selected accelerators and using a collective operation to move the data into the memory tier.

9. The method of claim 1, further comprising presenting, by the SFA, a virtualized view of memory to a CPU and the one or more accelerators to cause the CPU to access and write the data into the send queue of the memory tier and the SFA to copy the data from the memory tier into memory of the one or more accelerators based on the association between the send queue and the one or more receive queues.

10. The method of claim 9, further comprising mediating the CPU access by configuring the SFA to present a CXL memory device to the CPU.

11. The method of claim 1, wherein one or more of the send and receive send queues are implemented as queues managed by software or as embedded queues in hardware.

12. A system for using staging buffers in broadcast or multicast operations comprising:
a memory tier comprising a send queue and configured to be accessed by a plurality of accelerators and to receive data in the send queue; and
a server fabric adapter (SFA) communicatively coupled to the memory tier and the plurality of accelerators, wherein the SFA is configured to:
establish an association between buffers of the send queue and one or more receive queues based on a pattern of sharing defined by one or more of the plurality of accelerators; and
transmit the data to the one or more accelerators by sending the data from the send queue to the one or more receive queues based on the association.

13. The system of claim 12, wherein, to provide the memory tier, the SFA is further configured to perform at least one of assembling the memory tier from coherent memory blocks including compute express link (CXL) memory or attaching a standard compute unit via peripheral component interconnect express (PCIe).

14. The system of claim 12, wherein, the association is one-to-one, and to transmit the data from the send queue to the one or more receive queues, the SFA is further configured to send the data directly to a single receive queue using a media access control (MAC) address combined with a virtual local area network (VLAN) number.

15. The system of claim 12, wherein, the association is one-to-many, and to transmit the data from the send queue to the one or more receive queues, the SFA is further configured to send the data to multiple receive queues using a multicast address, wherein the multicast address represents a list of destinations' addresses, and each destination's address includes a MAC address combined with a VLAN number.

16. The system of claim 12, wherein the SFA is further configured to:
generate and provide an error descriptor in a receive queue from the one or more receive queues when the receive queue has an error or insufficient space; and
resend the data to the receive queue in response to determining that the receive queue includes an error descriptor.

17. The system of claim 12, wherein the one or more accelerators defining the pattern of sharing form a copy group.

18. The system of claim 17, wherein the SFA is further configured to create an arbitrary number of copy groups to provide sufficient capacity without increasing memory bandwidth requirements.

19. The system of claim 18, wherein the SFA is further configured to perform collective operations to move the data to selected accelerators by creating a multicast group with the selected accelerators and using a collective operation to move the data into the memory tier.

20. The system of claim 12, wherein one or more of the send and receive send queues are implemented as queues managed by software or as embedded queues in hardware.
